(19) United States
(12) Patent Application Publication
(10) Pub. No.: US 2010/0026184 A1
(43) Pub. Date: Feb. 4, 2010

(54) METAL HALIDE LAMP AND A CERAMIC BURNER FOR SUCH A LAMP

(75) Inventor: Josephus Christiaan Maria Hendricx, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., EINDHOVEN (NL)

(21) Appl. No.: 12/519,400

(22) PCT Filed: Dec. 13, 2007
(86) PCT No.: PCT/IB07/55075

§ 371 Date: Jun. 16, 2009

(30) Foreign Application Priority Data
Dec. 20, 2006 (EP) 06126720.9
Jun. 27, 2007 (EP) 07111178.5

(51) Int. Cl. H01J 61/30; H01J 9/38

(52) U.S. Cl. 313/634; 445/38

(57) ABSTRACT

A ceramic burner for a metal halide lamp, which ceramic burner comprises a discharge vessel (20) having a ceramic wall (30) enclosing a discharge space (24). The ceramic wall (30) of the discharge vessel (20) comprises a tube (62) for introducing an ionisable filling into the discharge vessel (20) during the manufacturing of the ceramic burner. The tube (62) protrudes outside the ceramic wall (30) of the discharge vessel (20) and is sealed gastight.

### FIELD OF THE INVENTION

The invention relates to a ceramic burner for a metal halide lamp, which ceramic burner comprises a discharge vessel enclosing a discharge space in a substantially gastight manner and being provided with an ionisable filling comprising one or more halides, the discharge vessel comprising a ceramic wall including two end portions, a conductor being embedded in each of the end portions for supplying electric current to respective electrodes arranged in the discharge space for maintaining a discharge.

### BACKGROUND OF THE INVENTION

Ceramic metal halide lamps contain fillings which comprise, besides a buffer gas, also metal halide salt mixtures such as NaCe iodide, NaTl iodide, NaSc iodide, NaTlDy iodide or combinations of these salts. These metal halide salt mixtures are applied to obtain, inter alia, a high lamp efficacy, a specific color corrected temperature and/or a specific color rendering index. Such a ceramic metal halide lamp comprises a discharge vessel enclosing a discharge space comprising the filling of the metal halide salt mixtures. The ceramic discharge vessel may have a substantially cylindrical tube-like portion both ends of which are closed by means of a ceramic end-plug, which ceramic plugs are co-sintered with the ceramic material of the tube-like portion. Thus, the ceramic wall of the discharge vessel is formed by the tube-like portion and the two end-plugs. The ceramic discharge vessel may also have another shape, for example, a shape such that the diameter of the central portion of the discharge vessel is larger than the diameter of the end portions of the discharge vessel.

The discharge space comprises two electrodes between which a discharge is maintained during operation of the lamp. Typically, the electrodes pierce through the end portions of the discharge vessel. In order to fill the ceramic metal halide lamp with the metal halide salt mixture, a filling-opening can be provided in the ceramic wall of the discharge vessel, which opening is closed, after the filling of the discharge space has taken place, by means of a closing-plug.

An embodiment of such a ceramic metal halide lamp is known from Japanese patent application JP10284002. In this known metal halide discharge lamp, the lamp consists of a gastight ceramic discharge vessel having two end-plugs made of a material having almost the same coefficient of thermal expansion; each end-plug guides an electrode. The ceramic discharge vessel further comprises a filling-opening. The filling is introduced into the discharge vessel through the filling-opening, which opening is subsequently closed by means of a T-shaped plug fitting into the filling-opening. The T-shaped plug is fused with the wall of the discharge vessel by exposing it to radiation from a laser. A disadvantage of the known ceramic metal halide lamp is that the T-shaped plug cannot be closed without substantially increasing the temperature of further portions of the discharge vessel, heating up the filling of the discharge vessel, in particular when the burner has relatively small dimensions.

### SUMMARY OF THE INVENTION

An object of the invention is to provide a ceramic burner for a ceramic metal halide lamp having a sealed filling-opening which has been closed without heating up the ionisable filling of the discharge vessel.

Another object of the invention is to provide a burner for a ceramic metal halide lamp having a sealed filling-opening which has been closed without causing cracks in the ceramic material of the discharge vessel.

Another object of the invention is to provide a burner for a ceramic metal halide lamp having a sealed filling-opening, the filling-opening of the burner being sealed relatively fast, i.e. in a short operation.

Another object of the invention is a metal halide lamp having means for facilitating the starting of the discharge process in the discharge vessel.

To accomplish one or more of these objects, the ceramic wall of the discharge vessel comprises a tube for introducing the ionisable filling into the discharge vessel during the manufacturing of the ceramic burner, the tube protruding outside the ceramic wall of the discharge vessel, and said tube being sealed gastight.

The use of a tube-like member, in this specification referred to as tube, enables the gastight seal to be arranged away from the ceramic wall of the discharge vessel at the protruding end of the tube. Due to the distance between the gastight seal and the ceramic wall, the tube can be sealed without damaging the ceramic wall of the discharge vessel and without heating up the ionisable filling of the discharge vessel too much.

In the ceramic burner according to JP10284002, the filling-opening is a bore in the wall of the discharge vessel. Sealing of the filling-opening is done by inserting a T-shaped plug into the bore and subsequently fusing the T-shaped plug to the ceramic wall of the discharge vessel by means of laser irradiation. Said laser irradiation causes an increase of the temperature of the T-shaped plug and of the temperature of a portion of the wall of the discharge vessel to the melting temperature of the ceramic material, which is around 2100° Celsius. This increase of the temperature creates a relatively large local temperature gradient which may result in cracks in the ceramic material of the discharge vessel. To reduce the occurrence of cracks, the known discharge vessel is sealed while a portion of the discharge vessel is heated up to approximately 800° Celsius for reducing the temperature gradient near the sinter location of the T-shaped plug. However, a further portion of the discharge vessel must be kept at a temperature below 350° Celsius to ensure that the ionisable filling does not evaporate and is blown out of the discharge vessel through the filling-opening before the discharge vessel is sealed gastight. To overcome this problem, said further portion of the discharge vessel has to be cooled.

In the ceramic burner according to the invention, the discharge vessel comprises the tube protruding away from the outer surface of the ceramic wall of the discharge vessel. After filling the discharge vessel with the ionisable filling through the tube, the protruding end of the tube is sealed. The protruding end of the tube extends away from the ceramic wall of the discharge vessel, so that it can be sealed without the ceramic wall being heated up to a temperature at which the ionisable filling of the discharge vessel evaporates, or at which the ionisable filling will expand in such a way that the plug is blown off the end of the tube. Furthermore, the relatively small temperature increase of the ceramic wall prevents cracks in the ceramic wall due to material stress and tension, which would result from a large temperature gradient.

Furthermore, by applying a tube as described above, the production time of the ceramic burner can be reduced, because only the relatively small protruding end of the tube has to be heated up in order to seal the tube.

As used herein, “ceramic” means a refractory material such as a monocrystalline metal oxide (e.g. sapphire), polycrystalline metal oxide (e.g. polycrystalline densely sintered aluminum oxide and yttrium oxide), and polycrystalline non-oxide material (e.g. aluminum nitride). Such materials allow wall temperatures of 1500° to 1700° Kelvin and resist chemical attacks by halides and other filling components. For the purpose of the present invention, polycrystalline aluminum oxide (PCA) has been found to be a very suitable material.

In a preferred embodiment, the tube is made of ceramic material, preferably substantially the same ceramic material as that used for the ceramic wall of the discharge vessel. By virtue thereof, stress and/or tension between the ceramic wall and the tube during operation of the ceramic metal halide lamp, and during the increase in temperature when applying the gastight seal is extremely low or even avoided.

Preferably, the ceramic tube protrudes more than 0.5 mm, preferably more than 1 mm, away from the outside surface of the ceramic wall of the discharge vessel. It has been found that such a length of the ceramic tube enables the required high temperature at the protruding end of the tube when sealing the tube, while the ceramic wall of the discharge vessel remains at a relatively low temperature.

In a preferred embodiment, the inner diameter of the ceramic tube is between 0.25 mm and 0.4 mm, and the wall thickness of the tube is between 0.15 mm and 0.25 mm. On the one hand, the inner diameter of the tube is large enough to introduce the ionisable filling into the ceramic vessel. On the other hand, too large an inner diameter requires too much tube-material to be molten for creating a gastight seal, resulting in a relatively high thermal strain during forming the gastight seal. Furthermore, on the one hand, the wall thickness of the ceramic tube must be sufficient to make the tube strong enough to withstand the thermal gradient occurring during the formation of the gastight seal and/or to allow enough ceramic wall material to be molten close to the protruding end of the tube. On the other hand, the wall thickness of the tube should not be too large, because melting the tube for creating the gastight seal would take a relatively long time, which also results in a relatively high thermal strain which might damage the tube during the formation of the gastight seal and/or which may result in too large an expansion of the ionisable filling. Preferably, the wall thickness should be substantially half the diameter of the tube.

In a preferred embodiment, the discharge vessel including the ceramic tube is made by injection molding. The injection molding process enables to produce the discharge vessel such that the ceramic tube is an integral part of the ceramic wall of the discharge vessel. In addition, the production process of the discharge vessel can be simplified, and the connection between the wall and the tube is very strong.

In another preferred embodiment, the material of the tube is metal. By making use of a metal tube, the time required for sealing the tube is shorter than when using a ceramic tube. The material used for the tube may be for example Mo (molybdenum) or a Mo-alloy, but preferably, the material used for the tube is an alloy comprising Ir (iridium), preferably comprising more than 95% iridium. Good results are obtained by making use of a metal tube comprising substantially iridium.

In a preferred embodiment, the metal tube protrudes at least 0.5 mm away from the outside surface of the ceramic wall of the discharge vessel. The length of the metal tube outside the surface of the ceramic vessel can be very small, because the sealing operation is relatively short, so that the temperature increase of the ceramic wall during the sealing operation is limited.

Preferably, the inner diameter of the metal tube is between 0.25 mm and 0.4 mm, and the wall thickness of the metal tube is between 0.075 mm and 0.2 mm. In experiments it has been found that such dimensions provide good results.

In a preferred embodiment, the tube protrudes from the inner surface of the ceramic wall into the discharge vessel, so that an end of the tube extends a little inside the discharge vessel. It has been found that thus a strong and gastight connection between the ceramic wall of the discharge vessel and the tube can be easily achieved.

In a preferred embodiment, the gastight seal of the tube is formed of molten material of the tube. In this process, the protruding end of the tube can be heated up by means of laser irradiation during a short time, which is a relatively simple process, which does not require any additional materials such as frit. The irradiation time depends on the material of the tube and on the dimensions of the tube and the power of the laser beam.

In another preferred embodiment, the gastight seal comprises a plug sealed to the tube; preferably the material of the plug is the same as the material of the tube. A benefit of this embodiment is that the use of a plug considerably reduces the area that must be sealed to generate the gastight seal. When a plug is applied in the protruding end of the tube, only the contact area between the plug and the tube has to be sealed. In general, this requires less time and less sealing material to be molten.

The plug has preferably a T-shape, or, in another preferred embodiment, a conical shape, or, in another preferred embodiment, a spherical shape. A benefit when using a T-shaped plug is that when applying the plug, the plug cannot be pushed into the discharge vessel. A benefit when using a conical shape is that tolerances of the dimensions of the protruding end of the tube may be less accurate. A benefit when using a substantially spherical shape is that when using placement tools for placing the plug on to the protruding end of the tube, the spherically shaped plug can be easily picked and placed by a placement tool.

Preferably, the plug is directly fused to the tube, without using additional material. By fusing the plug to the tube the use of a sealing frit is avoided. The protruding tube enables the plug to be directly fused to the protruding end of the tube, for example, by means of a short irradiation operation with a laser beam, while an increase of the temperature of the remainder of the discharge vessel is limited.

To start the discharge process in the burner, a relatively high voltage is required between the two electrodes, being a much higher voltage than the voltage that is required for maintaining the discharge process in the burner. The discharge process can be started by using a lower voltage, when the distance between the electrodes is smaller. For this purpose, a so-called starting electrode can be used, being a third electrode located nearer to one of the two main electrodes than the distance between the two main electrodes. As a result, the discharge process can be started by a relatively small voltage between one of the main electrodes and the starting electrode, and the discharge process can subsequently be maintained between the two main electrodes; at this stage the starting electrode is switched off.

In a preferred embodiment, such a starting electrode is inserted through the tube, so that the end of the starting electrode is located near one of the two main electrodes. Also, the electric current supply conductor passes through the tube, and the tube can be sealed by melting the material of the tube and the material of said conductor.

The invention furthermore relates to a method of manufacturing a ceramic burner for a metal halide lamp, which ceramic burner comprises a discharge vessel enclosing a discharge space in a substantially gastight manner, the discharge vessel comprising a ceramic wall including two end portions, a conductor being embedded in each of the end portions for supplying electric current to respective electrodes arranged in the discharge space for maintaining a discharge, and an ionisable filling comprising one or more halides being introduced into the discharge vessel through an opening in the wall of the ceramic burner, the ceramic wall of the discharge vessel being provided with a tube for supplying the ionisable filling into the discharge vessel, said tube protruding outside the ceramic wall of the discharge vessel and being sealed gastight after the discharge vessel has been filled.

### DESCRIPTION OF THE DRAWINGS

The invention will now be further elucidated by means of a description of some embodiments of a ceramic burner for a metal halide lamp, which ceramic burner comprises a discharge vessel surrounded by a ceramic wall, with reference to the drawing comprising seven diagrammatic Figures, wherein:

FIGS. 1, 2 and 3 are sectional views of three embodiments of a ceramic burner having a cylindrical discharge vessel;

FIG. 4 is a sectional view of an embodiment of a ceramic burner having a starting electrode;

FIGS. 5 and 6 are sectional views of embodiments of a ceramic burner having a ball-shaped discharge vessel; and

FIG. 7 shows a ceramic metal halide lamp.

The diagrammatic Figures are not drawn to scale. Particularly for clarity, some dimensions are exaggerated strongly. Similar parts in the different Figures are denoted by the same reference numerals.

### DETAILED DESCRIPTION OF THE EMBODIMENTS

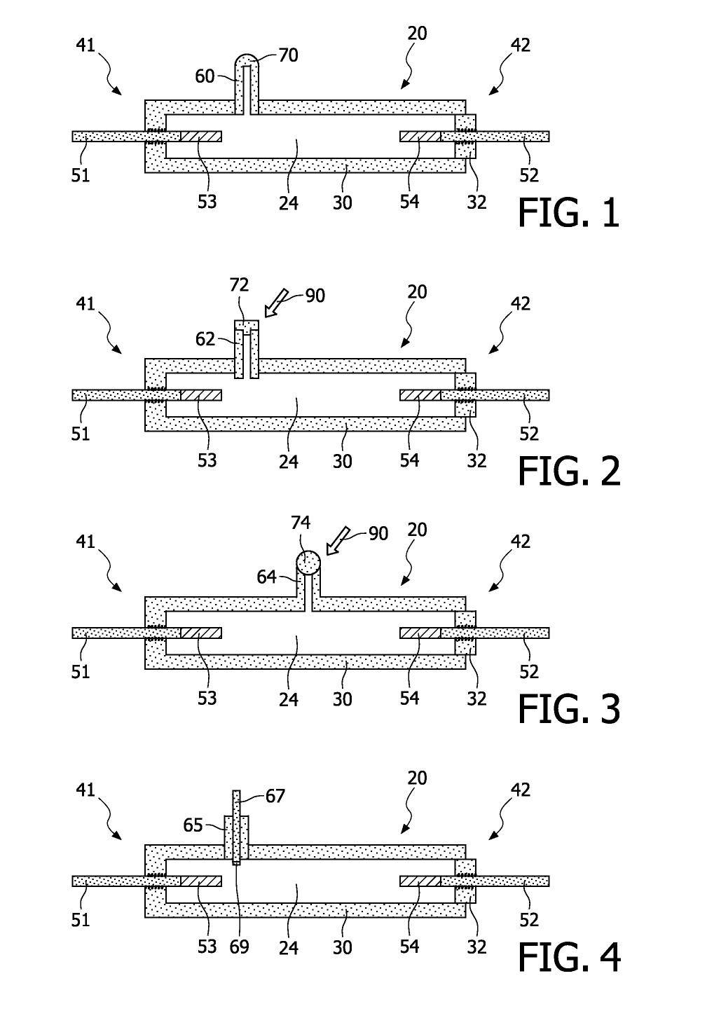

FIGS. 1, 2 and 3 show embodiments of the ceramic burner according to the invention, having a cylindrical discharge vessel 20 enclosing a discharge space 24. The discharge vessel 20 is substantially made of ceramic material, such as Aluminum-Oxide (Al₂O₃). The discharge vessel 20 comprises a tubular wall 30 and two end portions 41,42, in which end portions 41,42 current supply conductors 51,52 are embedded, so that they extend into the discharge space 24. The current supply conductors 51,52 are formed by a rod 51,52 directly sintered to the ceramic material of the discharge vessel 20, so that a seal is created. Inside the discharge vessel 20, an electrode 53,54 is connected to each of the current supply conductors 51,52. The electrodes 53,54 are made of Tungsten. The current supply conductors 51,52 are connected to the respective electrodes 53,54 for supplying power to the electrodes 53,54 for initiating and maintaining a light emitting discharge process in the discharge space 24.

In the embodiments shown in FIGS. 1, 2 and 3, one end portion 41 of the discharge vessel 20 and the tubular wall 30 are made as a solid part of the discharge vessel 20. The other end portion 42 of the discharge vessel 20 comprises a ceramic end-plug 32, which end-plug 32 is sintered with the ceramic material of the tubular wall 30. The end-plug 32 can be made of the same ceramic material as the material of the ceramic wall 30.

The ceramic burners shown in FIGS. 1, 2 and 3 furthermore comprise a tube 60,62,64 protruding away from the outside surface of the ceramic wall 30 of the discharge vessel 20. An ionisable filling is introduced into the discharge vessel 20 through the tube 60,62,64 during the manufacturing of the ceramic burner. After the ionisable filling has been introduced, the tube 60,62,64 is sealed gastight at its protruding end. The gastight seal 70,72,74 can be made by melting material of the end of the tube 60 (FIG. 1), or by fitting a plug 72,74 in the protruding end of the tube 62,64 (FIGS. 2 and 3). Anyway, for forming the gastight seal 70,72,74, the tube 60,62,64 and, if present, the plug 72,74 is heated, which heating operation can be limited to heating only the protruding end of the tube 60,62,64. Due to the distance between the gastight seal 70,72,74 and the ceramic wall 30 of the discharge vessel 20, the tube 60,62,64 can be sealed while the temperature increase of the remainder of the discharge vessel 20 is limited. Limiting the temperature increase of the discharge vessel 20 results in a relatively small temperature gradient in the material of the ceramic wall 30, which will avoid cracks in the ceramic material of the discharge vessel 20.

Furthermore, the temperature of the ionisable filling in the discharge vessel 20 should not exceed a certain value before the discharge vessel 20 is completely sealed, in order to prevent part of the ionisable filling from flowing out of the discharge vessel 20. A further benefit of applying the tube 60,62,64 is that local heating of the protruding end of the tube 60,62,64 can be achieved in a relatively short time, reducing the processing time for producing the ceramic burner.

FIG. 1 shows an embodiment of the ceramic burner of a metal halide lamp, wherein a portion of the material 70 of the protruding tube 60 is melted in order to seal the tube. In this embodiment the tube 60 is a separate part fixed in the ceramic wall 30 of the discharge vessel 20. The heating operation can take place by means of irradiation with a laser beam, and the tube 60 will close automatically when the material 70 of it melts.

FIG. 2 shows an embodiment of the ceramic burner, wherein the tube 62 also protrudes away from the inner surface of the ceramic wall 30 of the discharge vessel 20, so that an end of the tube 62 extends a little into the discharge space 24. The other end of the tube 62 extends at the outside of the wall 30 and is provided with a plug 72 for creating the gastight seal closing the discharge vessel 20. The plug 72 is fused to the protruding end of the tube 62 by locally heating the plug 72 and/or by locally heating the protruding end of the tube 62. In the embodiment shown in FIG. 2, the plug 72 is a T-shaped plug, which plug is preferably made of the same material as the material of the tube 62.

FIG. 3 shows an embodiment of the ceramic burner, wherein the tube 64 forms an integral part of the ceramic wall 30. In this example, the discharge vessel 20 is produced by an injection molding process (well known in the art), the tube 64 being created in the injection molding operation of the discharge vessel 20. The protruding end of the tube 64 is provided with a plug 74 having a substantially spherical shape, which shape may be a ball, an ellipsoid or the like. Due to the spherical shape, the orientation of the plug 74 on the protruding end of the tube 64 is substantially indifferent, simplifying the placement operation of the plug 74. In a preferred embodiment, the inner surface of the end portion of the tube 64 may be made conical, so that the spherical plug 74, which plug is smaller than shown in FIG. 3, can be inserted into the end portion of the tube 64. The plug 74 may be made of substantially the same material as the tube 64, so that the material of the plug 74 and the material of tube 64 will melt together when locally heating the plug 74 and/or when locally heating the protruding end of the tube 64. The heating operation can take place by means of irradiation of the protruding end of the tube 64 by means of a laser beam (indicated with an arrow 90).

FIG. 4 shows a further embodiment of the ceramic burner, wherein a tube 65 is fixed in the wall 30 of the discharge vessel 20, and a current supply conductor 67 is inserted into the tube 65 after the discharge space 24 is filled with the ionisable filling through the tube 65. The conductor 67 provides for closing and sealing the tube 65. The current supply conductor 67 is connected with a starting electrode 69, extending into the discharge space 24. When starting the discharge process in the discharge space 24, a starting voltage is present between the electrode 53 and the starting electrode 69, resulting in a discharge in the discharge space 24. After the discharge process is started, the required voltage for maintaining the discharge process is applied to the electrodes 53,54, and the starting electrode 69 is switched off. Because the starting electrode 69 is positioned nearer to the electrode 53 than the other electrode 54, the discharge process in the discharge space 24 can be initiated by a relatively low voltage, which voltage is much lower than the voltage for starting the discharge process in the burners shown in FIGS. 1, 2 and 3.

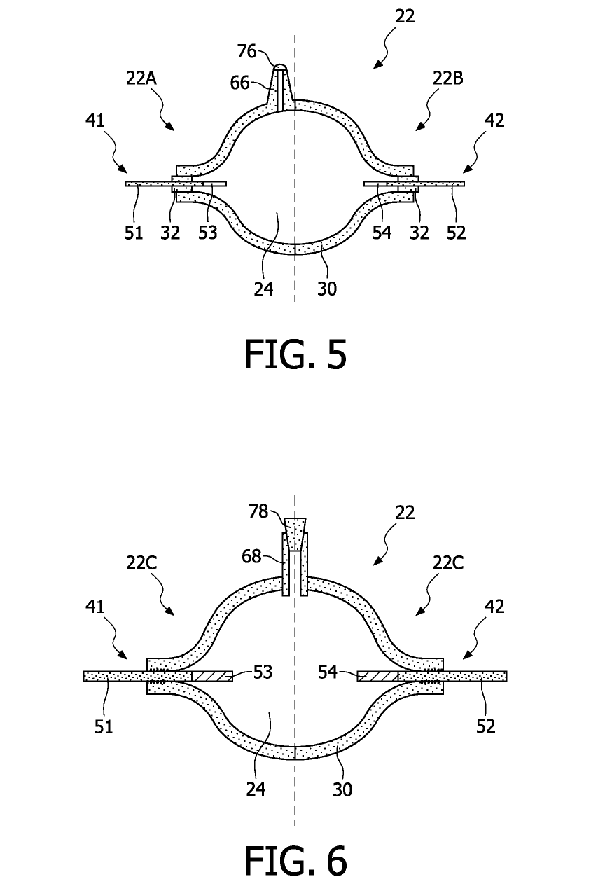

FIGS. 5 and 6 show two embodiments of the ceramic burner having a ball-shaped discharge vessel 22, which may result in a compact burner. The dimensions of a ceramic metal halide lamp can be relatively small when making use of such a ball-shaped discharge vessel 22. The discharge vessel 22 may be substantially ball-shaped or substantially ellipsoid-shaped. Because of the ball-shape, the temperature gradient in the ceramic wall 30 of the discharge vessel 20 is relatively small during operation of the burner.

FIG. 5 shows an embodiment of the ceramic burner comprising end portions 41,42, each comprising an end-plug 32. A current supply conductor 51,52 is embedded in each end-plug 32, so that the current supply conductor 51,52 can be directly sintered to the end-plug 32. The discharge vessel 22 is composed of two different parts 22A,22B (in the Figure, this is indicated by a dashed line). Only the left discharge vessel part 22A comprises a tube 66 having a gastight seal 76. Each of the two different parts 22A,22B may be produced by an injection molding process, well known in the art. In said process, the tube 66 is formed as an integral part of the left discharge vessel part 22A. The two different parts 22A,22B of the discharge vessel 22 are joined together by means of a sinter process. The gastight seal 76 at the protruding end of the tube 66 is created by molten material of the tube 66, for example, by irradiating the protruding end with a laser beam. Instead of making use of a laser beam, a glue can be used to close the tube. The location of the tube 66 is substantially in the middle between the end portions 41,42.

FIG. 6 shows an embodiment of the ceramic burner, wherein the tube 68 is fixed in the ceramic wall 30 of the discharge vessel 22. The protruding end of the tube 68 is provided with a plug 78, which plug 78 is fused to the tube 68 in order to create the gastight seal. The tube 68 and the plug 78 are made of the same material. The plug 78 is conically shaped, resulting in a convenient fit in the end of the tube 68. The location of the tube 68 is in the middle between the end portions 41,42. The discharge vessel 22 is constituted of two substantially identical parts 22C (at both sides of the dashed line in the Figure). Each of the parts 22C may be produced by means of an injection molding process or an extrusion process. The two substantially identical parts 22C are, for example, made of aluminum-oxide, which parts 22C are joined gastight by means of a sinter process in order to form the discharge vessel 22.

As an alternative embodiment, each of the two identical parts 22C may include one half of the tube 68, so that part 22C and half of the tube 68 form an integral part of the discharge vessel 22, and the two parts 22C, including the half tubes, can be fixed together by a sinter operation. In this embodiment, a single mould is required for producing both parts 22C of the discharge vessel 22.

The material of the tube 60,62,65,68 can be ceramic material or metal. The corresponding plug 72,74,78 is made of the same or similar material. Preferably, the ceramic material is the same as or similar to the material of the wall 30 of the discharge vessel 20. The metal tube can be made of iridium or molybdenum. The tube 60,62,65,68 is sintered in a bore in the ceramic wall 30 of the discharge vessel 20, in order to obtain a sealed connection with the ceramic wall 30. In the case of a metal tube 60,62,65,68, the tube and the wall 30 can be united by shrinking.

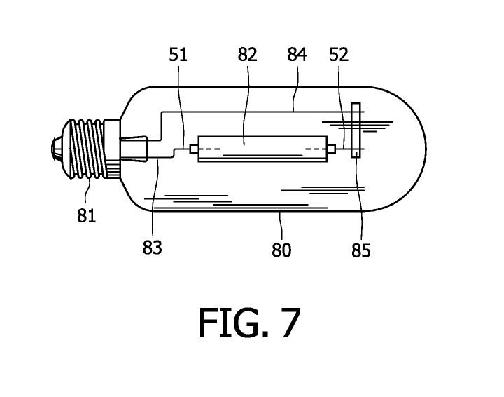

FIG. 7 shows a ceramic metal halide lamp according to the invention. The ceramic metal halide lamp comprises a transparent outer bulb 80 connected to a connection member 81, which connection member 81 can be screwed in a lamp holder. Inside the transparent outer bulb 80 is a ceramic burner 82 as shown in one of the FIGS. 1-3. The burner 82 is connected to connection member 81 by means of two metal conducting wires 83,84, which wires 83,84 keep the burner 82 in its predetermined position inside the outer bulb 80. The conducting wires 83,84 are connected to the two conductors 51,52 of the ceramic burner 82. A metal strip 85 is present between the conducting wire 84 and the conductor 52, so that electric current can be supplied from connection member 81 to the electrodes inside the burner 82.

The described embodiments are only examples of the ceramic burner according to the invention; many other embodiments are possible.

1. A ceramic burner for a metal halide lamp, which ceramic burner comprises a discharge vessel enclosing a discharge space in a substantially gastight manner and being provided with an ionisable filling comprising one or more halides, the discharge vessel comprising a ceramic wall including two end portions, a conductor being embedded in each of the end portions for supplying electric current to respective electrodes arranged in the discharge space for maintaining a discharge, characterized in that the ceramic wall of the discharge vessel comprises a tube for introducing the ionisable filling into the discharge vessel during the manufacturing of the ceramic burner, the tube protruding outside the ceramic wall of the discharge vessel, and said tube being sealed gastight.

2. A ceramic burner as claimed in claim 1, wherein the tube comprises a ceramic material.

3. A ceramic burner as claimed in claim 2, wherein the material of the tube is substantially the same ceramic material as the ceramic wall of the discharge vessel.

4. A ceramic burner as claimed in claim 2 wherein the tube protrudes more than 0.5 mm away from the outside surface of the ceramic wall of the discharge vessel.

5. A ceramic burner as claimed in claim 2, wherein the inner diameter of the tube is between 0.25 mm and 0.4 mm, and the wall thickness of the tube is between 0.15 mm and 0.25 mm.

6. A ceramic burner as claimed in claim 3, wherein the discharge vessel is made by injection molding.

7. A ceramic burner as claimed in claim 1, wherein the material of the tube is metal.

8. A ceramic burner as claimed in claim 7, wherein the material of the tube is an alloy comprising more than 95% iridium.

9. A ceramic burner as claimed in claim 7, wherein the metal tube protrudes at least 0.5 mm away from the outside surface of the ceramic wall of the discharge vessel.

10. A ceramic burner as claimed in any one of claims 7, wherein the inner diameter of the metal tube is between 0.25 mm and 0.4 mm, and the wall thickness of the metal tube is between 0.075 mm and 0.2 mm.

11. A ceramic burner as claimed in claim 1, wherein the tube protrudes from the inner surface of the ceramic wall into the discharge vessel.

12. A ceramic burner as claimed in claim 1, wherein the gastight seal of the tube is constituted of molten material of the tube.

13. A ceramic burner as claimed in claim 1, wherein the gastight seal comprises a plug sealed to the tube.

14. A ceramic burner as claimed in claim 7, wherein a starting electrode is inserted through the tube.

15. (canceled)

16. A method of manufacturing a ceramic burner for a metal halide lamp, which ceramic burner comprises a discharge vessel enclosing a discharge space in a substantially gastight manner, the discharge vessel comprising a ceramic wall including two end portions, a conductor being embedded in each of the end portions for supplying electric current to respective electrodes arranged in the discharge space for maintaining a discharge, and an ionisable filling comprising one or more halides being introduced into the discharge vessel through an opening in the wall of the ceramic burner, characterized in that the ceramic wall of the discharge vessel is provided with a tube for introducing the ionisable filling into the discharge vessel, which tube protrudes outside the ceramic wall of the discharge vessel and is sealed gastight after the discharge vessel has been filled.
